(19) United States
(12) Patent Application Publication
(10) Pub. No.: US 2025/0375857 A1
(43) Pub. Date: Dec. 11, 2025

(54) STEERING WHEEL RETENTION JIG

(71) Applicant: Toyota Motor Engineering & Manufacturing North America, Inc., Plano, TX (US)

(72) Inventors: Eric T. McCowen, Allendale, IL (US); Johnny R. Franklin, Vincennes, IN (US); Stephen W. Hightshoe, Princeton, IN (US); Steven D. Gaines, Evansville, IN (US)

(73) Assignees: Toyota Motor Engineering & Manufacturing North America, Inc., Plano, TX (US); Toyota Jidosha Kabushiki Kaisha, Toyota-shi (JP)

(21) Appl. No.: 18/734,440

(22) Filed: Jun. 5, 2024

(51) Int. Cl. B25B 11/02

(52) U.S. Cl. CPC B25B 11/02

(57) ABSTRACT

A steering wheel retention jig includes a resiliently deformable base, a first fastener-holding portion extending from the base, and a second fastener-holding portion extending from the base opposite and spaced apart from the first fastener-holding portion. First and second actuators extend from the base and are structured to enable the first and second fastener-holding portions to be moved farther away from each other. Increased separation between the first and second fastener-holding portions enables a portion of a steering wheel fastener to be inserted and gripped between the first and second fastener-holding portions, thereby applying or mounting the steering wheel retention jig to the fastener. This serves as an indication to users that the steering wheel has not been (and should not yet be) fully installed on the vehicle.

### TECHNICAL FIELD

The present invention relates to jigs used for assembly of vehicles and, more particularly, to a jig used when temporarily attaching a steering wheel to a vehicle during vehicle assembly operations.

### BACKGROUND

During assembly of a vehicle, it may be desirable to temporarily support or secure a steering wheel in a non-final position on the vehicle during to movement of the vehicle between different locations on the assembly floor. To temporarily secure the steering wheel to the vehicle during other assembly operations, a steering wheel fastener may be partially applied to the steering wheel. The fastener may be tightened enough to attach the steering wheel to the vehicle, but not tightened so far as to fully and permanently secure the steering wheel to the vehicle). This allows other, preliminary assembly operations to be performed prior to final tightening of the steering wheel fastener. However, without a discernible indication that the fastener should not yet be fully tightened, the fastener may inadvertently be tightened by a user prior to performance of the preliminary assembly operations. Also, with the fastener only partially tightened and without a discernible indication that the fastener should not yet be fully tightened, it is possible for a user to prematurely install a horn pad on the steering wheel.

### SUMMARY

In one aspect of the embodiments described herein, a steering wheel retention jig is provided. The jig includes a resiliently deformable base, a first fastener-holding portion extending from the base, and a second fastener-holding portion extending from the base opposite the first fastener-holding portion. A first actuator extends from the base and is structured to be movable to deform the base so as to move the first fastener-holding portion in a direction away from the second fastener-holding portion.

### BRIEF DESCRIPTION OF THE DRAWINGS

The accompanying drawings, which are incorporated in and constitute a part of the specification, illustrate various systems, methods, and other embodiments of the disclosure. In some embodiments, one element may be designed as multiple elements or multiple elements may be designed as one element. In some embodiments, an element shown as an internal component of another element may be implemented as an external component and vice versa. Furthermore, elements may not be drawn to scale. Also, unless otherwise stated or shown, the same or similar elements shown in different views may be given the same or similar reference numerals or designations.

FIG. 1 is a schematic perspective view of a steering wheel retention jig in accordance with an embodiment described herein.

FIG. 2 is the schematic perspective view of FIG. 1 showing the jig applied to a fastener used to attach a steering wheel to a vehicle.

FIG. 2A is a schematic side view of a portion of the jig shown in FIG. 2, showing a spacing provided between the steering wheel and a head portion of the fastener when the jig is applied to the steering wheel.

FIG. 3 a schematic perspective view of the jig of FIGS. 1 and 2 applied to a fastener applied to a steering wheel to secure the steering wheel to a vehicle.

### DETAILED DESCRIPTION

A steering wheel retention jig includes a resiliently deformable base and a first fastener-holding portion extending from the base. A second fastener-holding portion extends from the base opposite and spaced apart from the first fastener-holding portion. A first actuator extends from the base and is structured to be movable to deform the base so as to move the first fastener-holding portion in a direction away from the second fastener-holding portion. A second actuator extends from the base opposite and spaced apart from the first actuator. The second actuator is structured to be movable to deform the base so as to move the second fastener-holding portion in a direction away from the first fastener-holding portion. Separation of the first and second fastener-holding portions enables a portion of a steering wheel fastener to be inserted and gripped between the first and second fastener-holding portions, thereby applying or mounting the steering wheel retention jig to the fastener. This serves as an indication to users that the steering wheel has not been (and should not yet be) fully installed on the vehicle.

The various elements set forth in the following description may be fabricated from any material or materials (e.g., metals, polymers, etc.) suitable for the purposes described herein. Also, if desired, suitable threaded metallic inserts may be secured in any of the components described herein to facilitate the use of threaded fasteners attaching and securing the components to each other.

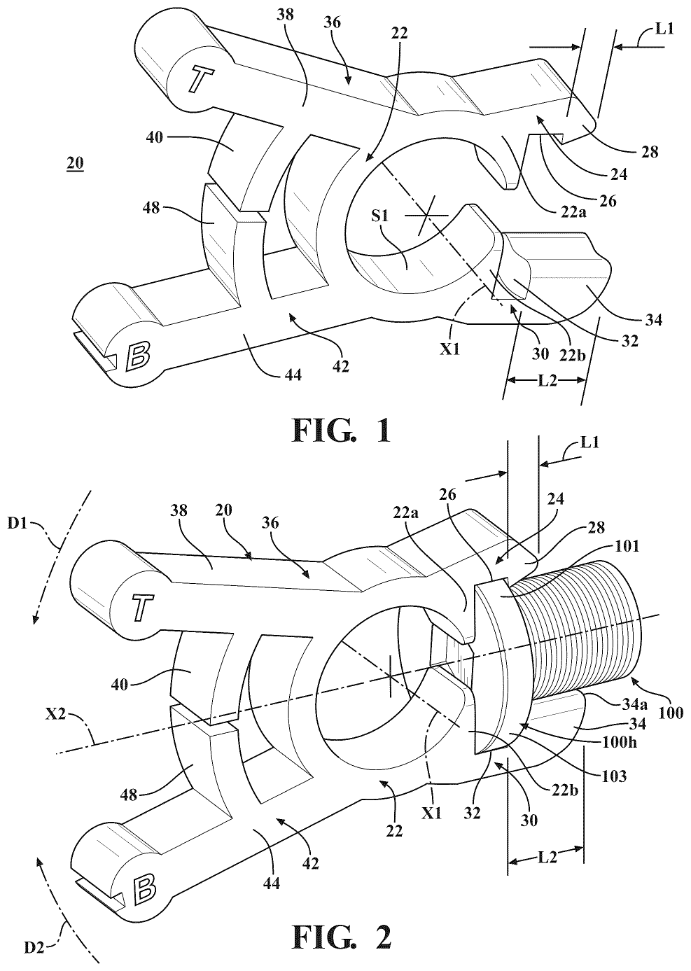

FIG. 1 is a schematic perspective view of a steering wheel retention jig 20 in accordance with an embodiment described herein. In one or more arrangements, the jig 20 may include a resiliently deformable base 22. As used herein, an element (or portion of an element) that is “resiliently deformable” has an unstressed or unloaded shape to which the element will return after an applied load causing deformation of the element has been removed. The element will return to its unloaded shape when unloaded if internal stresses resulting from the applied load were at or below a predetermined threshold magnitude or range of magnitudes. Application of an applied load above the threshold magnitude/range of magnitudes may induce internal stresses that cause the element to plastically (i.e., permanently) deform to some degree.

In one or more arrangements, the base 22 may have a semi-annular shape as shown in the drawings. “Semi-annular” means having a shape that resembles part of a ring or incomplete circular band. In other arrangements, the base may have an alternative shape. In the semi-annular configuration, the base 22 may have a first end 22a and a second end 22b. In particular arrangements, the base 22 may have an axis of curvature X1 structured to orthogonally intersect (i.e., to intersect at a right angle) a central longitudinal axis X2 of an associated fastener 100 when the jig 20 is applied to the fastener 100. The jig 20 is considered to be applied to the fastener 100 when the jig 20 is attached to the fastener 100. Referring to FIG. 1, in particular embodiments in which the base 22 has a semi-annular shape, the axis of curvature X1 may be a central axis of an inner semi-circular surface S1 defined by the base.

Referring to the drawings, the jig 20 may also include a first fastener-holding portion 24 extending from the base 22. A “fastener holding portion” of the jig 20 is a portion of the jig structured to grip, receive, enclose or otherwise engage a portion of a fastener 100 so as to enable the jig 20 to be attached to the fastener. The first fastener-holding portion 24 may include a first groove 26 structured to receive a first portion 101 of the fastener 100 therein, when the jig 20 is applied to the fastener 100. In one or more arrangements, the first portion 101 of the fastener 100 may be part of a head portion 100h of the fastener 100 adapted for operation of an assembly tool thereon. In some arrangements, the first groove 26 may be structured to receive the first portion 101 of the associated fastener 100 in a close sliding fit between opposed faces of the first groove 26.

The first fastener-holding portion 24 may have a first end portion 28 positioned adjacent the first groove 26. The first end portion 28 may be structured to extend between the first portion 101 of the fastener 100 and a steering wheel SW1 secured to a vehicle V1 by the fastener 100, when the fastener 100 is partially applied to the steering wheel SW1 and the jig 20 is applied to the fastener 100. The fastener 100 is “partially applied” to the steering wheel SW1 when the fastener 100 is applied so as to attach the steering wheel SW1 to the vehicle V1, but not tightened so far as to fully and permanently secure the steering wheel SW1 to the vehicle V1.

The jig 20 may also include a second fastener-holding portion 30 extending from the base 22 opposite from the first fastener-holding portion 24. The second fastener-holding portion 30 may include a second groove 32 structured to receive therein a second portion 103 of the fastener 100 positioned opposite or otherwise spaced from the first portion 101 of the fastener 100, when the jig 20 is applied to the fastener 100. In one or more arrangements, the second portion 103 of the fastener 100 may be part of the head portion 100h of the fastener 100 adapted for operation of an assembly tool thereon. In some arrangements, the second groove 32 may be structured to receive the second portion 103 of the associated fastener 100 in a close sliding fit between opposed faces 32a, 32b of the second groove 32.

The second fastener-holding portion 30 may also have a second end portion 34 positioned adjacent the second groove 32. The second end portion 34 may be structured to extend between the second portion 103 of the fastener 100 and the steering wheel SW1 when the fastener 100 is partially applied to the steering wheel SW1 and the jig 20 is applied to the fastener 100.

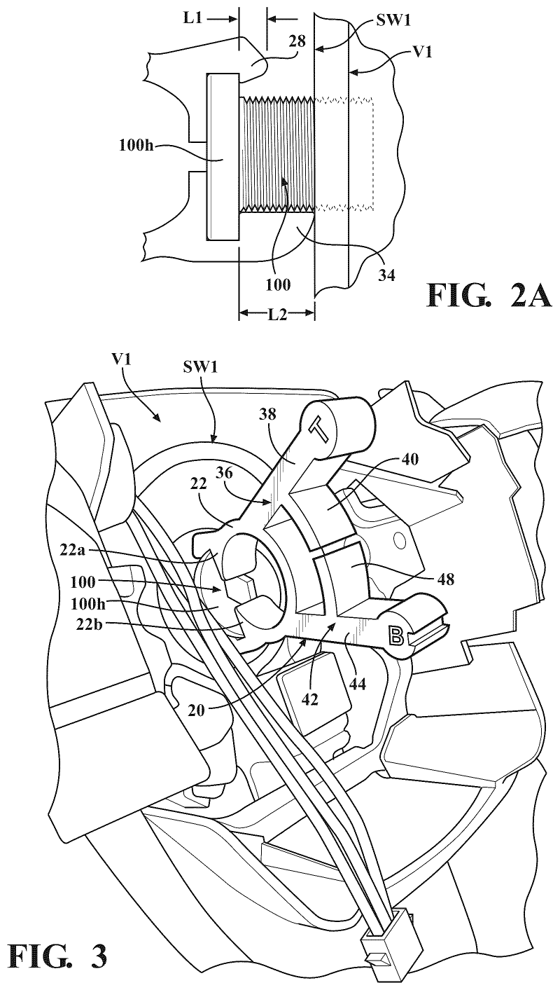

Referring to FIGS. 1-2A, in one or more arrangements, the jig 20 may be structured so that the second fastener-holding portion 30 is longer than the first fastener-holding portion 24. In such an arrangement, a length L2 of the second end portion 34 taken from the second groove 32 to an end tip 34a may be greater than a length L1 of the first end portion 28 taken from the first groove 26 to an end tip of the first end portion. The dimension L2 may be specified for a given length of fastener 100 so that, when attaching the steering wheel to the vehicle, the fastener 100 may be inserted into the steering wheel only a predetermined amount far enough to sufficiently retain the steering wheel on the vehicle V1 for purposes of preliminary assembly operations (i.e., so that the distance of at least L2 separates the fastener head portion 100h from the steering wheel SW1 when the fastener 100 has been tightened sufficiently into the vehicle V1 to retain the steering wheel SW1 to the vehicle). This arrangement preserves at least a minimum distance L2 between the fastener head portion 100h and the steering wheel SW1 needed for preliminary assembly operations. To provide at least the desired distance L2 between the fastener head portion 100h and the steering wheel SW1 (so that the second end portion 34 is positionable between the fastener head portion 100h and the steering wheel SW1), the position of fastener head portion 100h may be adjusted by tightening or loosening the fastener 100 as needed prior to application of the jig 20 to the fastener 100. The dimension L1 may be specified so as to provide clearance between the first end portion 28 and the steering wheel SW1 when the steering wheel is secured to the vehicle V1, to facilitate removal of the jig 20 after preliminary assembly operations are complete and prior to final tightening of the fastener 100.

The jig 20 may also include a first actuator 36 extending from the base 22 and structured to be movable to deform the base so as to move the first fastener-holding portion 24 in a direction away from the second fastener-holding portion 30.

In one or more arrangements, the first actuator 36 may include a first actuator arm 38 extending from the base 22. The first actuator arm 38 may be structured to enable deformation of a portion of the base 22 to which the first fastener-holding portion 24 is attached, responsive to movement of the first actuator arm 38.

The first actuator 36 may also include a first actuator stop 40 spaced apart from the base 22 and extending from the first actuator arm 38 in a direction toward a second actuator 42 having a second actuator arm 44 (described in greater detail below). An “actuator stop” may be a feature structured to limit movement of the first actuator toward the second actuator, or to limit movement of the second actuator toward the first actuator. The first actuator stop 40 may be structured to contact a portion of the second actuator 42 when the first actuator 36 has been moved a sufficient amount toward the second actuator 42. This contact is designed to stop further movement of the first actuator arm 38 toward the second actuator 42, thereby limiting deflection of the base 22 and movement of the first fastener-holding portion 24 resulting from the deflection of the base 22. This contact is also designed to aid in preventing overstressing of (and possible damage to) the base 22 due to excess deformation from actuator arm movement.

The second actuator 42 extends from the base 22 and structured to be movable to deform the base 22 so as to move the second fastener-holding portion 30 in a direction away from the first fastener-holding portion 24.

In one or more arrangements, the second actuator 42 may include second actuator arm 44 extending from the base 22 opposite the first actuator arm 38. The second actuator arm 44 may be structured to enable deformation of a portion of the base 22 to which the second fastener-holding portion 30 is attached, responsive to movement of the second actuator arm 44.

The second actuator 42 may also include a second actuator stop 48 spaced apart from the base 22 and extending from the second actuator arm 44 in a direction toward the first actuator 36 and opposite the first actuator stop 40. The second actuator stop 48 may be structured to contact a portion of the first actuator 36 when the second actuator 42 has been moved a sufficient amount toward the first actuator 36. This contact is designed to stop further movement of the second actuator arm 44 toward the first actuator arm 38, thereby limiting deflection of the base 22 and movement of the second fastener-holding portion 30 resulting from the deflection of the base 22. This contact is also designed to aid in preventing overstressing of (and possible damage to) the base 22 due to excess deformation from actuator arm movement.

In one or more particular arrangements, the first and second actuators 36, 42 are structured to be rotated simultaneously in opposite directions D1, D2 to deflect the base ends 22a, 22b and effect simultaneous movement of the first and second fastener-holding portions 24, 30 away from each other. In particular arrangements, the first and second actuator stops 40, 48 are aligned with each other so as to contact each other after sufficient movement of the first and second actuator arms 38, 44 toward each other, thereby stopping further deflection of the base 22 and further movement of the first and second fastener-holding portions 24, 30 away from each other.

In one or more arrangements, an orientation designator may be applied to one or more of the actuator arms 38, 44 to inform a user of a particular desired orientation of the jig 20 when applied to the fastener 100. For example, in particular arrangements, the actuator arms 38, 44 are to extend along a vertical plane with a particular one of the first fastener-holding portion 24 and the second fastener-holding portion 30 gripping a relatively lower portion of the fastener 100 and the other fastener-holding portion gripping a relatively higher portion of the fastener 100 when the jig 20 is applied to the fastener. To facilitate application in this orientation, an orientation designator “T” (for “top”) may be provided on an end of the first actuator arm 38 and an orientation designator “B” (for “bottom”) may be provided on an end of the second actuator arm 44. Other positions and types of orientation designators are also possible.

FIG. 2 is the schematic perspective view of FIG. 1 showing the jig applied to a fastener used to attach a steering wheel to a vehicle. FIG. 3 a schematic perspective view of the jig of FIGS. 1 and 2 applied to a fastener applied to a steering wheel to secure the steering wheel to a vehicle. Referring to FIGS. 2 and 3, in operation, a fastener 100 may be partially applied to the steering wheel SW1 an amount sufficient to hold the wheel in place on the vehicle V1 without finally and fully attaching the steering wheel SW1 to the vehicle V1. a user may then grip the jig 20 along the first and second actuator arms 38, 44 and squeeze the jig 20 so as to move the first and second actuator arms 38, 44 toward each other (in directions D1 and D2, respectively) an amount sufficient to separate the first and second fastener-holding portions 24, 30 enough to enable the head portion 100h of the fastener 100 to be inserted into respective first and second grooves of the first and second fastener-holding portions 24, 30. First and second portions of the head of the fastener may then be inserted into first and second grooves 26, 32 of the respective first and second fastener-holding portions.

Depending on the material(s) from which the base 22 is formed, the dimensions of the base 22, and other pertinent parameters, dimensions and/or shapes of each of the first and second actuator stops 40, 48 may be adjusted to some degree to enable the separation between the first and second fastener-holding portions 24, 30 to be modified for different diameters or sizes of fastener head 100h.

During assembly of the vehicle V1, the jig 20 applied to the fastener 100 may indicate to assembly personnel that the steering wheel SW1 is not finally and fully attached to the vehicle V1. Also, since the jig 20 is structured and positioned to block access to the head portion 100h of the fastener 100 when the jig 20 is applied to the fastener 100, the jig 20 acts to prevent inadvertent further tightening of the fastener 100 prior to completion of other assembly steps that must be performed prior to final tightening of the fastener 100 to secure the wheel SW1 to the vehicle V1. The jig 20 also prevents inadvertent or premature installation of a horn pad (not shown) to the steering wheel SW1 when the jig 20 is applied. Also, due to the structures and positioning of the end portions 28, 34 of the respective first and second fastener holding portions 24, 30, the jig 20 cannot be mistakenly attached to the fastener 100 when the fastener is fully and finally tightened to secure the steering wheel Sw1 to the vehicle V1.

Embodiments of the steering wheel retention jig 20 described herein may be formed from any suitable material or materials (e.g., polymers). Embodiments of the steering wheel retention jig 20 described herein may be fabricated as a single piece by any suitable method, such as 3-D printing or molding, for example. Alternatively, the steering wheel retention jig 20 may be assembled from separate constituent elements.

In the above detailed description, reference is made to the accompanying figures, which form a part hereof. In the figures, similar symbols typically identify similar components, unless context dictates otherwise. The illustrative embodiments described in the detailed description, figures, and claims are not meant to be limiting. Other embodiments may be utilized, and other changes may be made, without departing from the scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein.

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e. open language). The phrase “at least one of . . . and . . . ” as used herein refers to and encompasses any and all possible combinations of one or more of the associated listed items. As an example, the phrase “at least one of A, B and C” includes A only, B only, C only, or any combination thereof (e.g. AB, AC, BC or ABC).

Aspects herein can be embodied in other forms without departing from the spirit or essential attributes thereof. Accordingly, reference should be made to the following claims, rather than to the foregoing specification, as indicating the scope of the invention.

What is claimed is:

1. A steering wheel retention jig comprising;
a resiliently deformable base;
a first fastener-holding portion extending from the base;
a second fastener-holding portion extending from the base opposite the first fastener-holding portion; and
a first actuator extending from the base and structured to be movable to deform the base so as to move the first fastener-holding portion in a direction away from the second fastener-holding portion.

2. The steering wheel retention jig of claim 1, further comprising a second actuator extending from the base opposite the first actuator and structured to be movable to deform the base so as to move the second fastener-holding portion in a direction away from the first fastener-holding portion.

3. The steering wheel retention jig of claim 2, wherein the first actuator includes a first actuator stop spaced apart from the base and extending in a direction toward the second actuator.

4. The steering wheel retention jig of claim 3, wherein the first actuator stop is structured to contact a portion of the second actuator when the first actuator has moved a sufficient amount toward the second actuator.

5. The steering wheel retention jig of claim 4, wherein the portion of the second actuator is a second actuator stop spaced apart from the base and extending opposite the first actuator stop in a direction toward the first actuator.

6. The steering wheel retention jig of claim 1, wherein the first fastener-holding portion includes a first groove structured to receive a first portion of a fastener therein when the jig is applied to the fastener, and the second fastener-holding portion includes a second groove structured to receive therein a second portion of the fastener spaced apart from the first portion of the fastener, when the jig is applied to the fastener.

7. The steering wheel retention jig of claim 6, wherein the first fastener-holding portion has an end portion structured to extend between the first portion of the fastener and a steering wheel secured to a vehicle by the fastener, when the fastener is partially applied to the steering wheel and the jig is applied to the fastener.

8. The steering wheel retention jig of claim 1, wherein the base has a semi-annular shape.

9. The steering wheel retention jig of claim 8, wherein the base has an axis of curvature structured to orthogonally intersect a central longitudinal axis of the fastener when the jig is applied to the fastener.

10. The steering wheel retention jig of claim 1, wherein the second fastener-holding portion is longer than the first fastener-holding portion.
